(19) United States
(12) Patent Application Publication
(10) Pub. No.: US 2014/0064738 A1
(43) Pub. Date: Mar. 6, 2014

(54) SMART GATEWAY AND SMART HOME NETWORK SYSTEM USING THE SAME

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/014,344

(22) Filed: Aug. 29, 2013

(30) Foreign Application Priority Data
Aug. 31, 2012 (CN) 2012103179669

(51) Int. Cl. G08C 23/04

(52) U.S. Cl. CPC G08C 23/04
USPC 398/112

(57) ABSTRACT

A smart home network system includes a number of home devices, a smart gateway, and a control device. The smart gateway stores a mapping list that records configuration information of each home device, and the configuration information contains a UID code of each home device. When received a control signal for controlling a target home device from the control device, the smart gateway analyzes the control signal and modulates the control signal with the UID of the target home device and converts network protocols, to generate an effective control command, then transmits the control command to the target home device. When received status information from the home devices, and the smart gateway sends the status information to the control device for reading status information of the home devices. Therefore, user can operate the control device anywhere to remote control each individual home device via the smart gateway.

### BACKGROUND

1. Technical Field

The present disclosure relates to smart home technology, and particularly to a smart gateway and a smart home network system using the smart gateway.

2. Description of Related Art

Smart home technology is becoming more popular. With this technology, home devices in a house are connected to a smart home network system, to be controlled by the smart home network system.

However, the home devices applied in existing smart home network system are controlled by wired control signals, which cause a bandwidth requirement. In addition, rewiring for a house is needed when the smart home network system is applied to the house at the first time. However, as a result of the large number of the home devices and existing wiring, rewiring for a house is difficult, and will destroy existing decoration of the house, and further increase the cost.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a smart home network system, according to an embodiment. The system includes a smart gateway, a number of home devices, at least one register controller, and a control device.

FIG. 2 is a block diagram of the smart gateway of FIG. 1.

FIG. 3 is a block diagram of the home device of the system of FIG. 1.

FIG. 4 is a block diagram of a register controller of the system of FIG. 1.

FIG. 5 is a flowchart illustrating a method for registering the number of home devices with the smart gateway of FIG. 1.

FIG. 6 is a schematic diagram of a mapping list stored in the smart gateway of FIG. 2.

FIG. 7 is a schematic diagram of a control interface displayed on the smart gateway of FIG. 2 or on the control device of FIG. 1.

FIG. 8 is another schematic diagram of a control interface displayed on the smart gateway of FIG. 2 or on the control device of FIG. 1.

### DETAILED DESCRIPTION

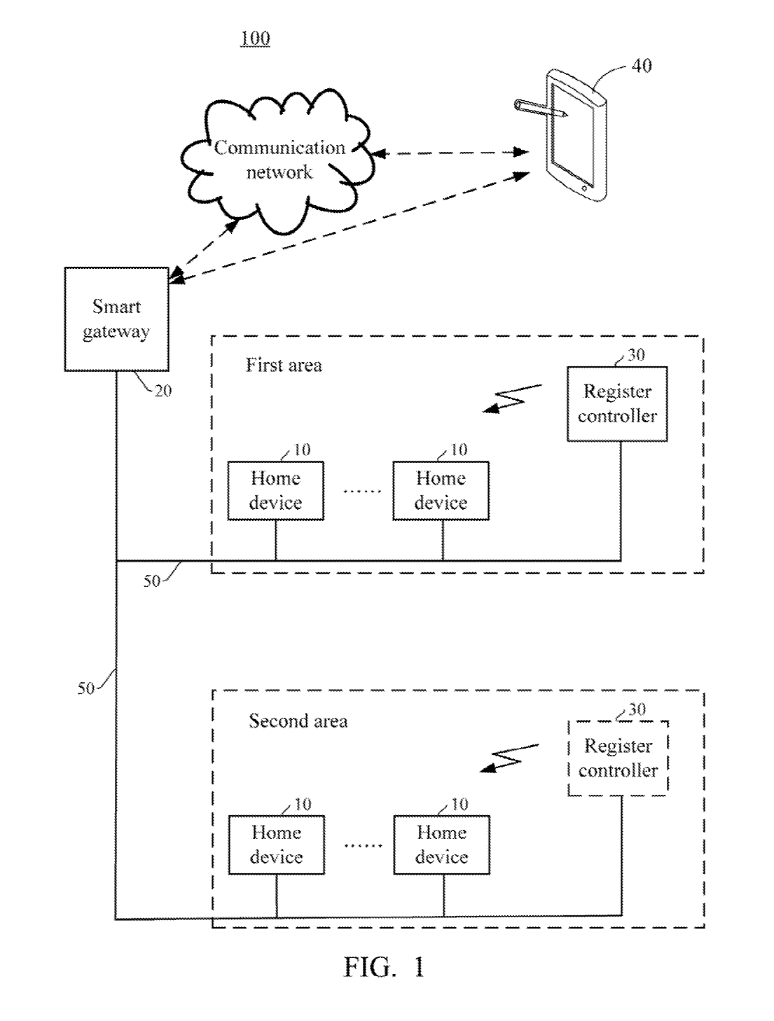

FIG. 1 is a smart home network system 100 of the embodiment. The system 100 includes a number of home devices 10, a smart gateway 20 and a control device 40. The home devices 10 may include, but are not limited to, a refrigerator, an air conditioner, an electric curtain, a lamp, and a smart socket.

In this embodiment, the smart gateway 20 is connected to a communication network, and communicates with the control device 40 via wired communication technology or wireless communication technology. The smart gateway 20 receives control signals for controlling target home devices from the control device 40, and sends the control signals to the target home devices. The smart gateway 20 also receives status information from the home devices 10, and sends the status information to the control device 40 for reading status information of the home devices. Therefore, user can operate the control device 40 in his hands to remote control each individual home device 10 at anywhere and anytime via the smart gateway 20.

In this embodiment, each device in the system 100 is provided with a unique identification (UID) code so that it can be uniquely identified by other devices.

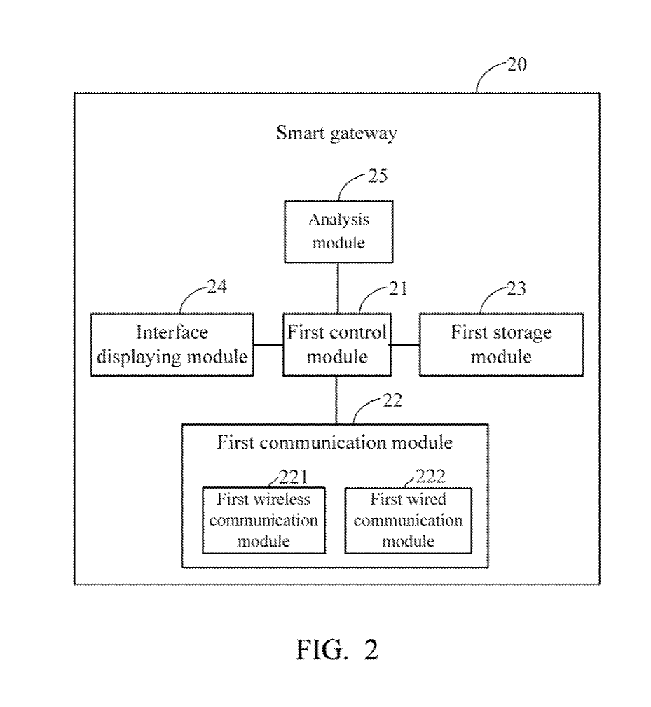

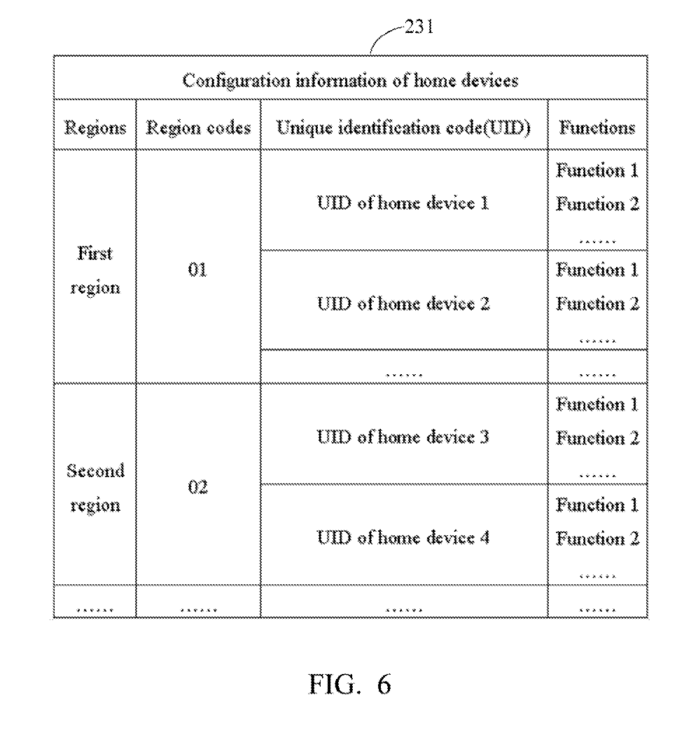

FIG. 2 shows that the smart gateway 20 includes a first control module 21, a first communication module 22, a first storage module 23, an interface displaying module 24, and an analysis module 25. The first storage module 23 stores the UID code of the smart gateway 20 and a mapping list 231 (as shown in FIG. 6). The mapping list 231 records the configuration information of each home device 10 in the system 100. In this embodiment, the configuration information contains region codes representing areas where the home devices 10 are placed, and the UID codes and functions of each home device 10.

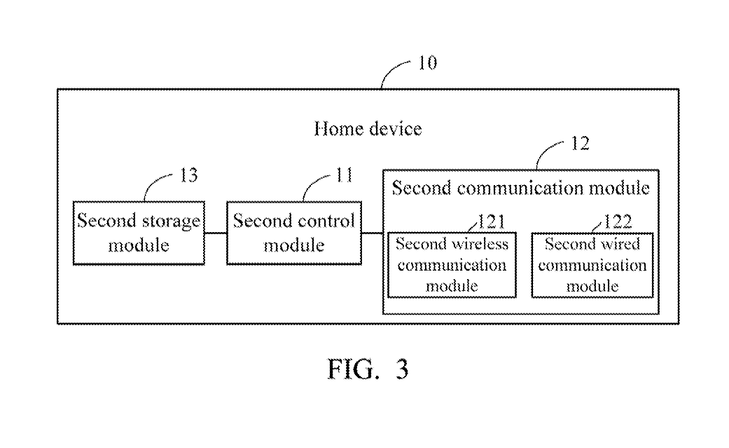

FIG. 3 shows that each home device 10 includes a second control module 11, a second communication module 12, and a second storage module 13. The second storage module 13 stores the UID code of the home device 10. Each home device 10 needs to register its configuration information with the smart gateway 20, when the home device 10 is connected to the system 100 for the first time or is re-connected to the system 100, to allow the smart gateway 20 to obtain the configuration information of each home device 10 to control each home device 10.

FIG. 1 shows that the system 100 further includes at least one register controller 30, each of which can be placed in a particular area (such as a room or a kitchen) of the house. In this embodiment, the register controller 30 can be an independent physical device, or be contained in a particular home device 10 in the area. Each register controller 30 controls a number of home devices 10 in the particular area where the register controller 30 is placed to register their configuration information with the smart gateway 20. In this embodiment, the register controller 30 generates and sends a registration request to the smart gateway 20 in order to start a registration process for registering the home devices 10 in the particular area. The register controller 30 further generates and sends a registration code to the home devices 10, in order to control the home devices 10 to register their configuration information with the smart gateway 20.

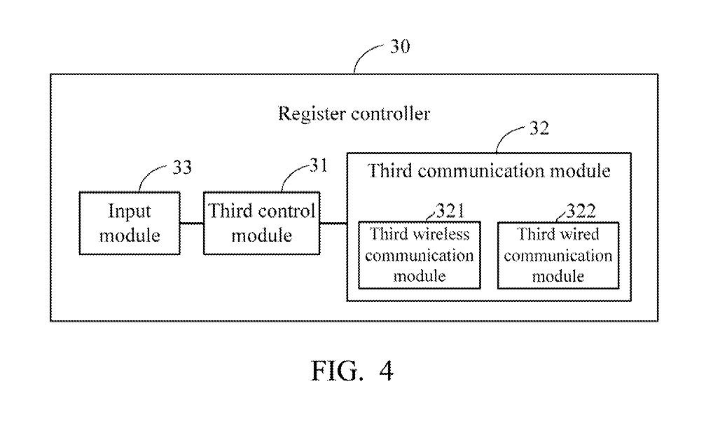

FIG. 4 shows that the register controller 30 includes a third control module 31, a third communication module 32, and an input module 33. The input module 33 is a button or a touch screen on the register controller 30 configured to allow a user to input information.

Functions of the above modules of the home device 10, the smart gateway 20, and the register controller 30 will be described in detail as shown in the following.

In this embodiment, the smart gateway 20 communicates with the home devices 10 and the register controller 30 via wireless communication technology. Referring again to FIGS. 2-4, in this embodiment, the first communication module 22 includes a first wireless communication module 221, the second communication module 12 includes a second wireless communication module 121, and the third communication module 32 includes a third wireless communication module 321. The first wireless communication module 221, the second wireless communication module 121, and the third wireless communication module 321 are all able to emit and receive near field wireless signals. The near field wireless signals may include, but are not limited to, infrared, BLUETOOTH, Z-wave, NFC, ZigBee, and WIFI signals. In all embodiments of this present disclosure, each of the first wireless communication module 221, the second wireless communication module 121, and the third wireless communication module 321 is an infrared signal transceiver.

The smart gateway 20 also communicates with the home devices 10 and the register controller 30 via wired communication technology. In this embodiment, the first communication module 22 further includes a first wired communication module 222, the second communication module 12 further includes a second wired communication module 122, and the third communication module 32 further includes a third wired communication module 322. The first wired communication module 222, the second wired communication module 122, and the third wired communication module 322 communicate with each other via Power Line Communication (PLC), Optical Fiber Power Line Communication (OPLC), Internet communication, coaxial cable communication, telephone line communication, or other communication technologies.

In all embodiments of this present disclosure, the smart gateway 20 is connected to each home device 10 and the register controller 30 via power lines 50, and the first wired communication module 222, the second wired communication module 122, and the third wired communication module 322 communicate with each other via PLC or OPLC technologies. Each of the first wired communication module 222, the second wired communication module 122, and the third wired communication module 322 is a modulation module, which extracts data from or injects data to the power lines 50. Therefore, the power lines 50 not only supply power to the devices, but also serve as a carrier for data transmission.

In the embodiment, the first wired communication module 222, the second wired communication module 122, and the third wired communication module 322 receive incoming data packets (PLC or OPLC data packets) from the power lines 50, and demodulate the data packets and convert network protocols as required. The first wired communication module 222, the second wired communication module 122, and the third wired communication module 322 also modulate to-be-transmitted data of the device and convert network protocols, and then send the to-be transmitted data to other devices via the power lines 50. With such a structure, the home devices 10 and the register controllers 30 can be connected to the system 100 by being directly plugged into existing power sockets in existing wiring of a house.

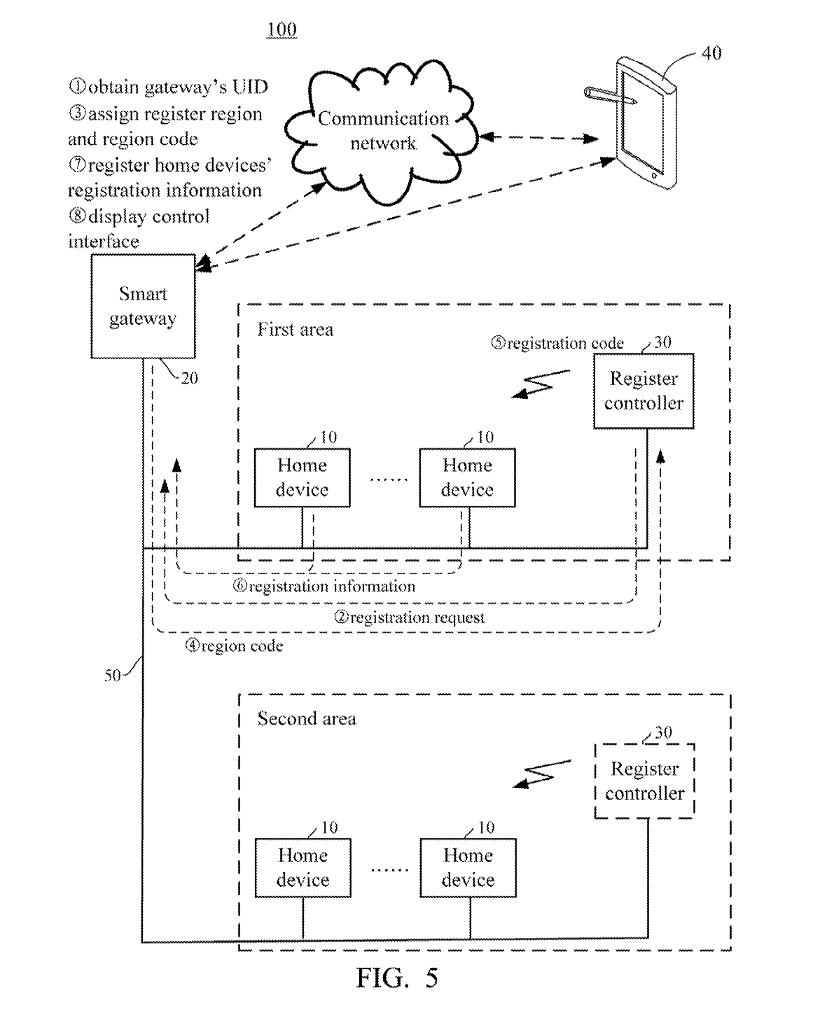

FIG. 5 shows a method for registering a number of home devices 10 with a smart gateway 20.

In step 1, the register controller 30 obtains the UID code of the smart gateway 20 via the third wireless communication module 321.

In this embodiment, the gateway 20 initiates a registration process, and the first control module 21 controls the first wireless communication module 221 to send out the UID code of the gateway 20. Because the wireless technology employed is infrared transmission, the register controller 30 is carried to the smart gateway 20, such that the register controller 30 is within range of the infrared signal.

In step 2, the register controller 30 is carried to a first area and is connected to the system 100. The third control module 31 of the register controller 30 generates the registration request in response to user's input in the input module 33. The third control module 31 controls the third wired communication module 322 to send the registration request to the smart gateway 20 via the power lines 50.

In this embodiment, the registration request contains the UID code of the smart gateway 20 and the UID code of the register controller 30.

In step 3, when the first wired communication module 222 of the smart gateway 20 receives the registration request from the register controller 30, the first control module 21 assigns a register region and a region code in the mapping list 231 (as shown in FIG. 5) for the home devices 10 in the first area.

In a first embodiment, the at least one register controller 30 includes a number of register controller 30, each of which is placed in a particular area in the house. The first control module 21 of the smart gateway 20 assigns the UID code of the register controller 30 that sent out the registration request as the region code for the home devices 10 in the first area. In a second embodiment, the at least one register controller 30 includes only one register controller 30, which can be moved to different areas of the house at different times. The first control module 21 of the smart gateway 20 assigns the region code according to a number or an order of the received registration requests, for example.

In step 4, the first wired communication module 222 of the smart gateway 20 sends the region code back to the register controller 30 that sent out the registration request via the power lines 50.

In step 5, when the third wired communication module 322 of the register controller 30 received the region code, the third control module 31 generates the registration code that contains the region code and the UID code of the smart gateway 20, and the third wireless communication module 321 wirelessly sends the registration code to all of the home devices 10 in the first area.

In step 6, when the home devices 10 in the first area received the registration code from the register controller 30 via their second wireless communication modules 121, the second control modules 11 control the second wired communication modules 122 to send their registration information to the smart gateway 20 via the power lines 50.

In this embodiment, the registration information contains the UID code of the smart gateway 20, the region code, and the configuration information of the home devices 10. The configuration information contains the UID code and functions of the home devices 10. The second storage module 13 of the home device stores the UID of the smart gateway 20 for future communication with the smart gateway 20.

In a third embodiment, the first control module 21 of the smart gateway 20 further generates an enquiry message that contains the region code, and controls the first wired communication module 222 to send the enquiry message to all home devices 10 in the system 100 via the power lines 50. The enquiry message is a signal that is used to distinguish the home devices 10 that have received the registration code sent by the register controller 30, that is, to distinguish which home devices 10 are in the same area as the register controller 30 that sent out the registration request. When the home devices 10 received the enquiry message from the smart gateway 20 via their second wired communication modules 122 and received the registration code from the registration controller 30 via their second wireless communication modules 121, the second control modules 11 of the home devices 10 determine whether or not the region code contained in the received enquiry message is the same as the region code contained in the registration code. If the region code contained in the received enquiry message matches the region code contained in the registration code, the second control modules 11 of the home devices 10 control the second wired communication modules 122 to send their registration information to the smart gateway 20.

In step 7, when the first wired communication module 222 of the smart gateway 20 receives the registration information from the home devices 10, the first control module 21 registers the configuration information of the home devices 10 in the corresponding register region in the mapping list 231. Therefore, the configuration information of the home devices 10 placed in the same area is registered in the same register region in the mapping list 231.

If a new home device 10 is added to a registered area (that is, the registration information of the home devices in the area have been registered in the mapping list 231 of the smart gateway 20) and needs to be registered with the smart gateway 20, the process repeats steps 2˜7 again.

It should be noted that, due to the UID code of each home device 10 being unique, the registration information of each home device 10 will only be registered once in the mapping list 231. If a home device 10 is moved to a new area, the registration information of the home device 10 registered in an original register region in the mapping list 231 will be deleted, and the registration information will be registered in a new register region in the mapping list 231.

The registration process for other home devices 10 placed in other areas is similar to steps 1˜7.

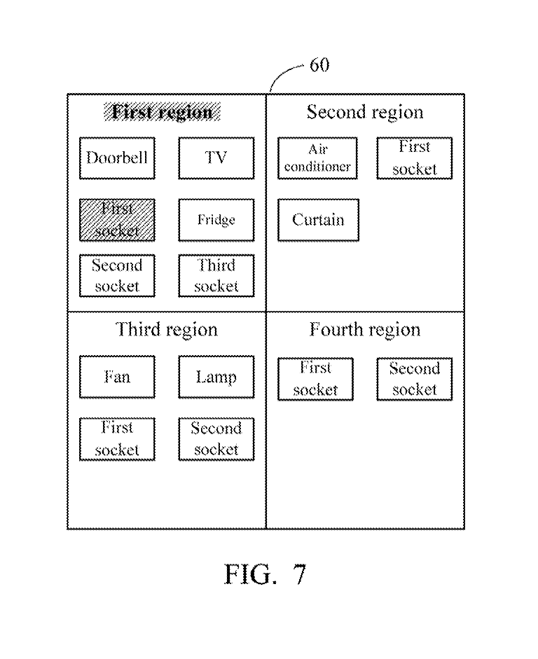

In step 8, the interface displaying module 24 of the smart gateway 20 displays a control interface 60 (as shown in FIG. 7), according to the mapping list 231. In this embodiment, the control interface 60 includes a number of regions corresponding to the areas in the house. Each region includes a number of icons corresponding to the home devices 10 placed in a corresponding area in the house, and each icon includes corresponding control options to control the corresponding home device 10.

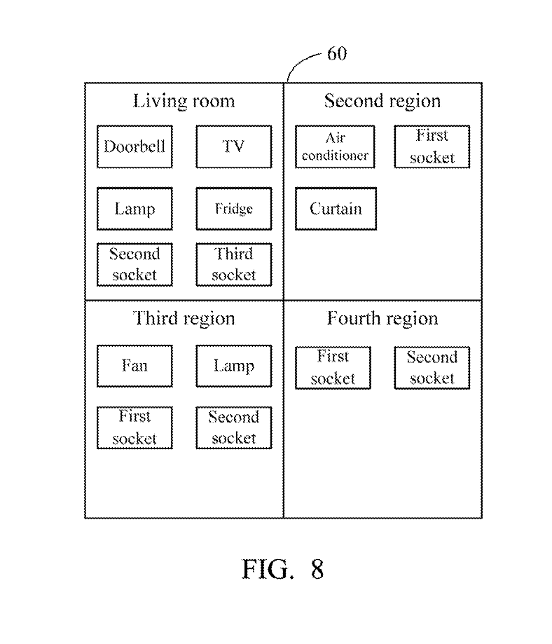

In this embodiment, the interface displaying module 24 displays a schematic diagram of the regions according to the region codes of the mapping list 231, displays the icons of the home devices 10 in the corresponding regions according to their corresponding UID codes and the region codes registered in the mapping list 231, and displays the control options for the corresponding icons according to the functions of the corresponding home devices 10 registered in the mapping list 231. The user can rename the regions or the icons. For example, as shown in FIG. 8, the user can rename the first region as “living room” and a first socket as “lamp.”

Such that, the registration process of the home devices 10 with the smart gateway 20 is completed.

FIGS. 1 and 2 show that the first communication module 22 of the gateway 20 can communicate with the control device 40 via near field wireless communication technology. Correspondingly, the control device 40 may be selected from a group consisting of a mobile phone, a tablet computer, and a notebook computer, which is provided with BLUETOOTH, Z-wave, ZigBee, or WIFI communication functions. The first communication module 22 can also communicate with the control device 40 via Internet, GPRS, GSM, CDMA, 3G, or 4 G communication technologies. Correspondingly, the control device 40 may be a computer, which can be connected to Internet, or may be a mobile phone, which is provided with GPRS, GSM, CDMA, 3G, or 4 G communication functions.

The control device 40 displays the control interface 60 according to the mapping list 231 stored in the smart gateway 20, such that the user can control each of the home devices 10 remotely.

In the embodiment, when a user selects a function option of a target home device in a particular region on the control interface 60, the control device 40 generates a control signal for controlling a target home device in response to user's selection, and sends the control signal to the smart gateway 20.

When the smart gateway 20 receives the control signal from the control device 40, the analysis module 25 analyzes the control signal, and reads the UID code of the target home device 10 from the configuration information recorded in the mapping list 231. The first wired communication module 222 modulates the control signal with the UID of the target home device 10 and converts network protocols, to generate an effective control command, and then transmits the control command to the target home device 10 via the power lines 50.

The second wired communication module 122 of the target home device 10 receives the control command transmitted from the smart gateway 20 via the power lines 50, and demodulates the control command and converts network protocols as required. In this embodiment, although all the home devices 10 can receive the control commands transmitted from the power lines 50, only the target home device 10 having the UID code matching the UID code contained in the control command can demodulate the control command and convert network protocols as required. The second control module 11 actives functions of the target home device 10 in response to the control command.

In this embodiment, the second control module 11 further obtains the status information of the home device 10. The second wired communication module 122 further modulates the status information with the UID of the home device 10 and converts network protocols, and transmits the modulated status information to the smart gateway 20 via the power lines 50.

The first communication module 22 of the smart gateway 20 further transmits the status information of the home device 10 to the control device 40.

Therefore, the system 100 allows a user to operate the remote control device 40 in his hands to remotely control any target home device or read the status of the home devices at anywhere and anytime.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart gateway applied to a smart home network system, the system comprising a plurality of home devices connected to the smart gateway, the smart gateway comprising:
a first storage module storing a UID code of the smart gateway and a mapping list, wherein the mapping list records configuration information of each home device in the system, and the configuration information contains a UID code of each home device;
a first communication module configured to receive a control signal for controlling a target home device from a control device; and
an analysis module configured to analyze the control signal, and read the UID code of the target home device from the configuration information recorded in the mapping list;
wherein the first communication module modulates the control signal with the UID of the target home device and converts network protocols, to generate an effective control command, and then transmits the control command to the target home device.

2. The smart gateway as described in claim 1, wherein the first communication module comprises a first wireless communication module, the first wireless communication module emits and receives near field wireless signals, so as to enable the smart gateway to communicate with the home devices and the control device via wireless communication technology, wherein the near field wireless signal is selected from a group consisting of infrared, Bluetooth, Z-wave, NFC, ZigBee, and WIFI signals.

3. The smart gateway as described in claim 1, wherein the first communication module comprises a first wired communication module, the first wired communication module emits and receives wired signals, so as to enable the smart gateway to communicate with the home devices via wired communication technology, wherein the wired communication technology is selected from a group consisting of PLC, OPLC, Internet communication, coaxial cable communication, and telephone line communication technologies.

4. The smart gateway as described in claim 1, wherein the smart gateway is connected to each home device via power lines, the first communication module comprises a first wired communication module, which is configured to receive incoming data packets from the power lines, and demodulate the data packets and convert network protocols as required; the first wired communication module further configured to modulate to-be-transmitted data of the device and convert network protocols, and then send the to-be transmitted data to other devices via the power lines.

5. The smart gateway as described in claim 1, wherein the first communication module communicates with the control device via Internet, GPRS, GSM, CDMA, 3G, or 4 G communication technologies.

6. A smart home network system comprising a plurality of home devices, a smart gateway, and a control device, the smart gateway comprising:
a first storage module storing a UID code of the smart gateway and a mapping list, wherein the mapping list records configuration information of each home device in the system, and the configuration information contains a UID code of each home device;
a first communication module configured to receive a control signal for controlling a target home device from the control device;
an analysis module configured to analyze the control signal, and read the UID code of the target home device from the configuration information recorded in the mapping list; wherein the first communication module modulates the control signal with the UID of the target home device and converts network protocols, to generate an effective control command; and
a first control module configured to control the first communication module to transmit the control command to the target home device.

7. The system as described in claim 6, wherein each home device comprises a second control module and a second communication module, wherein the second communication module receives the control command transmitted from the smart gateway, and demodulates the control command and converts network protocols as required; and the second control module actives functions of the target home device in response to the control command.

8. The system as described in claim 7, wherein the second control module further obtains the status information of the home device, and the second wired communication module further modulates the status information with the UID of the home device and converts network protocols, and transmits the modulated status information to the smart gateway; wherein the first communication module of the smart gateway further transmits the status information of the home device to the control device.

9. The system as described in claim 7, further comprising at least one register controller connected to the smart gateway, wherein each register controller comprises:
an input module and a third control module, the third control module configured to generate registration request in response to user's input in the input module;
a third communication module configured to obtain the UID of the smart gateway and a region code assigned by the smart gateway, and send the registration request to the smart gateway, wherein the third control module further generate a registration code that contains the region code and the UID code of the smart gateway, and the third communication module sends the registration code to all of the home devices in the area where the register controller is placed.

10. The system as described in claim 9, wherein when the second communication module of the home device receives the registration code from the register controller, the second control module controls the second communication module to send the registration information of the home device to the smart gateway.

11. The system as described in claim 10, wherein when the first communication module of the smart gateway received the registration request from the register controller, the first control module assigns a register region and the region code in the mapping list for the home devices in the area where the register controller is placed, and the first communication module sends the region code back to the register controller that sent out the registration request.

12. The system as described in claim 11, wherein when the first communication module of the smart gateway received the registration information from the home devices, the first control module registers the configuration information of the home devices in the corresponding register region in the mapping list.

13. The system as described in claim 12, wherein the smart gateway further comprises an interface displaying module, the interface displaying module is configured to display a control interface according to the mapping list, wherein the control interface comprises a plurality of regions, each region comprises a plurality of icons corresponding to the home devices placed in a corresponding area.

14. The system as described in claim 9, wherein each of the first communication module, the second communication module, and the third communication module comprises a wireless communication module, which emits and receives near field wireless signals, so as to enable the smart gateway to communicate with the home devices and the register controller via wireless communication technology, wherein the near field wireless signal is selected from a group consisting of infrared, Bluetooth, Z-wave, NFC, ZigBee, and WIFI signals.

15. The system as described in claim 9, wherein each of the first communication module, the second communication module, and the third communication module comprises a wired communication module, which emits and receives wired signals, so as to enable the smart gateway to communicate with the home devices and the register controller via wired communication technology, wherein the wired communication technology is selected from a group consisting of PLC, OPLC, Internet communication, coaxial cable communication, and telephone line communication technologies.

16. The system as described in claim 9, wherein the smart gateway is connected to each home device and the register controller via power lines, and communicates with each home device and the register controller via PLC or OPLC technologies; each of the first communication module, the second communication module, and the third communication module comprises a wired communication module, which is a modulation module, and is configured to extract data from or inject data to the power lines.

17. The system as described in claim 6, wherein the first communication module of the smart gateway communicates with the control device via Internet, GPRS, GSM, CDMA, 3G, or 4 G communication technologies.
